(19) United States
(12) Patent Application Publication
(10) Pub. No.: US 2021/0097297 A1
(43) Pub. Date: Apr. 1, 2021

(54) IMAGE PROCESSING METHOD, ELECTRONIC DEVICE AND STORAGE MEDIUM

(71) Applicant: SHENZHEN SENSETIME TECHNOLOGY CO., LTD., Shenzhen (CN)

(72) Inventors: Sijie REN, Shenzhen (CN); Zhouxia WANG, Shenzhen (CN); Jiawei ZHANG, Shenzhen (CN)

(21) Appl. No.: 17/118,682

(22) Filed: Dec. 11, 2020

Related U.S. Application Data
(63) Continuation of application No. PCT/CN2020/086812, filed on Apr. 24, 2020.

(30) Foreign Application Priority Data
May 9, 2019 (CN) 201910385228.X

(51) Int. Cl. G06K 9/00; G06T 5/00; G06T 5/50

(52) U.S. Cl. CPC G06K 9/00771; G06T 5/003; G06T 5/50; G06T 2207/30201; G06T 2207/20081; G06T 2207/20084; G06T 2207/20016; G06K 9/00288

(57) ABSTRACT

The present disclosure relates to an image process method, an electronic device and a storage medium. The method comprises: acquiring a first image; acquiring at least one guided image of the first image, wherein the guided image includes guide information of a target object in the first image; and obtaining a reconstructed image by subjecting the first image to a guide reconstruction based on the at least one guided image of the first image. The embodiments of the present disclosure can improve definition of reconstructed images.

The present disclosure is a continuation of and claims priority under 35 U.S.C. 120 to PCT Application. No. PCT/CN2020/086812, filed on Apr. 24, 2020, which claims priority to Chinese Patent Application No. 201910385228.X, filed with the Chinese Patent Office on May 9, 2019, and titled “IMAGE PROCESSING METHOD AND APPARATUS, ELECTRONIC DEVICE AND STORAGE MEDIUM”. All the above-referenced priority documents are incorporated herein by reference in their entity.

### TECHNICAL FIELD

The present disclosure relates to the technical field of computer vision, and in particular, to an image processing method and apparatus, an electronic device, and a storage medium.

### BACKGROUND

In the related art, due to shooting surroundings or configurations of an imaging device or other factors, the captured images may include poor images, from which face detection or other types of target detections are difficult to implement, and such images can be reconstructed with the aid of some models or algorithms. With noise and blur mixed in, a majority of methods for reconstructing low-pixel images have a difficulty in recovering fine images.

### SUMMARY

The present disclosure proposes a technical solution concerning image processing.

According to one aspect of the present disclosure, provided is an image processing method, comprising: acquiring a first image; acquiring at least one guided image of the first image, wherein the guided image includes guide information of a target object in the first image; and obtaining a reconstructed image by subjecting the first image to a guide reconstruction based on the at least one guided image of the first image.

According to second aspect of the present disclosure, provided is an image processing apparatus, comprising: a first acquisition module configured to acquire a first image; a second acquisition module configured to acquire at least one guided image of the first image, wherein the guided image includes guide information of a target object in the first image; and a reconstruction module configured to obtain a reconstructed image by subjecting the first image to a guide reconstruction based on the at least one guided image of the first image.

According to third aspect of the present disclosure, provided is an electronic device, comprising:

a processor; and a memory configured to store processor-executable instructions; wherein the processor is configured to invoke instructions stored in the memory to carry out the method according to the first aspect.

According to fourth aspect of the present disclosure, provided is a computer readable storage medium having computer program instructions stored thereon, wherein when the computer program instructions are executed by a processor, the method according to the first aspect is implemented.

According to fifth aspect of the present disclosure, provided is a computer readable code, wherein when the computer readable code operates in an electronic device, a processor of the electronic device carries out the method according to the first aspect.

It should be understandable that the general description above and the following description are merely exemplary and explanatory, instead of restricting the present disclosure.

Additional features and aspects of the present disclosure will become apparent from the following detailed description of exemplary embodiments with reference to the attached drawings.

### BRIEF DESCRIPTION OF THE DRAWINGS

The drawings herein, which are incorporated in and constitute part of the specification, together with the description, illustrate embodiments in line with the present disclosure and serve to explain the technical solutions of the present disclosure.

FIG. 1 shows a flowchart of an image processing method according to embodiments of the present disclosure.

FIG. 2 shows a flowchart of step S20 of an image processing method according to embodiments of the present disclosure.

FIG. 3 shows a flowchart of step S30 of an image processing method according to embodiments of the present disclosure.

FIG. 4 shows another flowchart of step S30 of an image processing method according to embodiments of the present disclosure.

FIG. 5 shows a schematic diagram for the process of an image processing method according to embodiments of the present disclosure.

FIG. 6 shows a flowchart of training a first neural network according to embodiments of the present disclosure.

FIG. 7 shows a schematic structural diagram for training a first neural network according to embodiments of the present disclosure.

FIG. 8 shows a flowchart of training a second neural network according to embodiments of the present disclosure.

FIG. 9 shows a block diagram for an image processing apparatus according to embodiments of the present disclosure.

FIG. 10 shows a block diagram for an electronic device according to embodiments of the present disclosure.

FIG. 11 shows another block diagram for an electronic device according to embodiments of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the examples are shown in the drawings, it is unnecessary to proportionally draw the drawings unless otherwise specified.

Herein the term “exemplary” means “used as an instance or example, or explanatory”. An “exemplary” example given here is not necessarily construed as being superior to or better than other examples.

The term “and/or” herein represents only an association relationship describing associated objects and indicates that there may be three relationships. For example, A and/or B may indicate the following three cases: only A, both A and B, and only B. In addition, the term “at least one” herein indicates any one of multiple listed items or any combination of at least two of multiple listed items. For example, including at least one of A, B, or C may indicate including any one or more elements selected from the group consisting of A, B, and C.

Numerous details are given in the following detailed description of embodiments for the purpose of better explaining the present disclosure. It should be understood by a person skilled in the art that the present disclosure can still be implemented even without some details. In some examples, methods, means, units and circuits that are well known to a person skilled in the art are not described in detail, so that the principle of the present disclosure become apparent.

It may be understood that the foregoing method embodiments mentioned in the present disclosure may be combined with each other to obtain a combined embodiment without departing from the principle and the logic. Details are not described in the present disclosure due to space limitation.

In addition, the present disclosure further provides an image processing apparatus, an electronic device, a computer readable storage medium, and a program. The foregoing are all used to implement any image processing method provided in the present disclosure. For corresponding technical solutions and descriptions, refer to corresponding descriptions of the method. Details are not repeated.

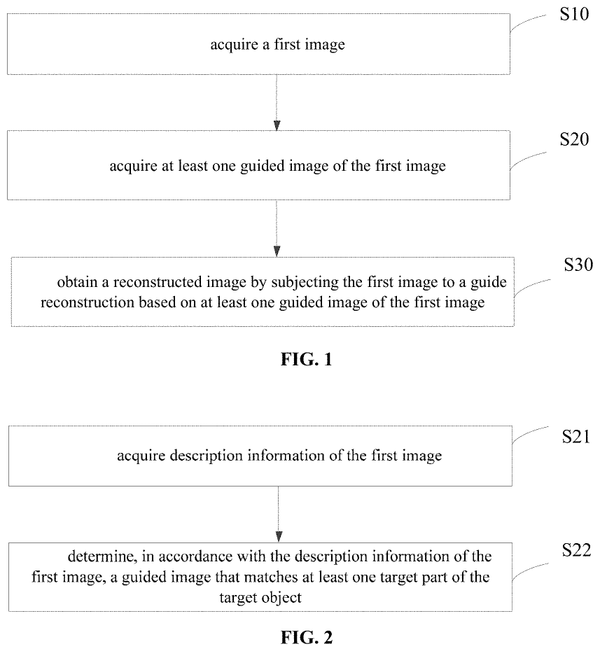

FIG. 1 shows a flowchart of an image processing method according to embodiments of the present disclosure. As shown in FIG. 1, the image processing method can comprise:

S10: acquiring a first image;

An executive body of the image processing method according to embodiments of the present disclosure may be an image processing apparatus. For instance, an image processing method may be executed by a terminal device or a server or other processing apparatus. Of these, the terminal device may be User Equipment (UE), a mobile device, a user terminal, a terminal, a cellular phone, a cordless phone, a Personal Digital Assistant (PDA), a handheld device, a computing device, a vehicle-mounted device, a wearable device, or the like. The server may be a local server or a cloud server. In some possible implementations, the image processing method can be implemented by a processor invoking computer readable instructions stored in a memory. An apparatus may serve as an executive body of the image processing method according to embodiments of the present disclosure as long as it can implement image processing.

In some possible implementations, first of all, an image object to be processed, i.e., a first image is obtainable. The first image in the embodiments of the present disclosure may be an image having a relatively low resolution and poor image quality. By the method in the embodiments of the present disclosure, the resolution of the first image can be improved to obtain a fine reconstructed image. In addition, the first image may include a target object of a target type. For example, the target object in the embodiments of the present disclosure may be a facial object, that is, reconstruction of a facial image is implementable according to embodiments of the present disclosure, so as to conveniently recognize person information. In other embodiments, the target object may be other types, such as animals, plants or other objects, etc.

Besides, in the embodiments of the present disclosure, the method of acquiring a first image includes at least one of receiving a transmitted first image, selecting a first image from the memory space in accordance with the received selection instruction, and acquiring the first image collected by an image collection device. The storage space can be a local storage address, or a network storage address. The foregoing is only an exemplary explanation, but is not a specific limitation of acquiring a first image in the present disclosure.

S20: acquiring at least one guided image of the first image, wherein the guided image includes guide information of a target object in the first image;

In some possible implementations, the first image can be configured with at least one corresponding guided image. The guided image includes guide information of a target object in the first image, for example, including guide information of at least one target part of the target object. For instance, when the target object is human face, the guided image may include an image of at least one part of the person matching the identity of the target object, e.g., an image of at least one target part such as eyes, nose, eyebrows, mouth, face shape, and hair. Alternatively, the guided image may also be an image of clothes or another part, which is not specifically limited in the present disclosure. As long as an image is usable to reconstruct a first image, it can serve as a guided image in the embodiments of the present disclosure. In addition, the guided images in the embodiments of the present disclosure are high-resolution images, so as to enhance the definition and accuracy of the reconstructed image.

In some possible implementations, guided images that match first images may be received from other devices, or guided images may be obtained in accordance with the acquired description information about the target objects. The description information may include at least one feature information of the target object. For example, in the case where the target object is a facial object, the description information may include feature information of at least one target part of the facial object, or the description information may directly include overall description information of the target object in the first image, e.g., description information of the target object that is an object with a known identity. From the description information, it is possible to determine a similar image of at least one target part of the target object in the first image, or to determine an image including an object as same as the object in the first image, and the resulting similar images or images including the same object may serve as guided images.

In one example, the suspect's information provided by one or more eyewitnesses may serve as description information, from which at least one guided image is formed. In the meantime, based on the suspect's first image obtained via a camera or by other approaches, guided images are utilized to reconstruct this first image to obtain a fine image of the suspect.

S30: obtaining a reconstructed image by subjecting the first image to a guide reconstruction based on the at least one guided image of the first image.

Upon obtaining of at least one guided image corresponding to the first image, the reconstruction of the first image can be executed using the obtained at least one guided image. As the guided image includes guide information of at least one target part of the target object in the first image, the guide information can be used to guide the reconstruction of the first image. Also, even if the first image were a severely degraded image, it would also be possible to reconstruct a finer reconstructed image in accordance with the guide information.

In some possible implementations, a guided image of the corresponding target part may be directly substituted into the first image to obtain a reconstructed image. For instance, in the case where the guided image includes a guided image of the eye part, the guided image of the eye part may be substituted into the first image. In this manner, a corresponding guided image may be directly substituted into the first image to complete the image reconstruction. This method is simple and convenient, and can integrate the guide information of a plurality of guided images into the first image conveniently, to implemente reconstruction of the first image. Because the guided images are fine images, the resulting reconstructed image will also be a fine image.

In some possible implementations, a reconstructed image may also be obtained by subjecting a guided image and a first image to convolution processing.

In some possible implementations, since the pose of the object in the guided image of the target object in the first image is probably distinct from the pose of the target object in the first image, there is a need to warp guided images in accordance with the first image. That is, the pose of the object in the guided image is adjusted so that it is consistent with the pose of the target object in the first image, and thereafter, reconstruction processing is executed on the first image by using the pose-adjusted guided image. The accuracy of the reconstructed image obtained by this process will be improved.

In view of the embodiments above, the embodiments of the present disclosure may conveniently implement the reconstruction of a first image based on at least one guided image of the first image. Fused with guide information of guided images, the resulting reconstructed image has a high definition.

Processes of the embodiments of the present disclosure are detailed below with reference to the attached drawings.

FIG. 2 shows a flowchart of step S20 of an image processing method according to embodiments of the present disclosure. Acquiring at least one guided image of the first image (step S20), comprises:

S21: acquiring description information of the first image;

As set out above, the description information of the first image may include feature information (or feature description information) of at least one target part of the target object in the first image. For example, in the case where the target object is a human face, the description information may include feature information of at least one target part, such as eyes, nose, mouth, ears, face, skin color, hair and eyebrows, of the target object, for example, the description information may be eyes looking like the eyes of A (a known object), the shape of eyes, the shape of nose, the nose looking like the nose of B (a known object), and so forth; or the description information may directly include the description that the overall target object in the first image looks like C (a known object). Alternatively, the description information may also include identity information of the object in the first image, and the identity information may include name, age, gender, etc. that can be used to determine the information of the identity of the object. The foregoing is only intended to exemplarily explain the description information, but is not intended to limit the description information of the present disclosure, and other information related to the object may be used as description information.

In some possible implementations, a method for acquiring the description information may include at least one of the following methods: receiving description information input via an input component and/or receiving an image with label information (the part labeled by the label information is a target part that matches the target object in the first image). In other embodiments, the description information may also be received in other ways, which is not specifically limited in the present disclosure.

S22: determining, in accordance with the description information of the first image, a guided image that matches at least one target part of the object.

Upon obtaining of the description information, a guided image that matches the object in the first image can be determined in accordance with the description information. When the description information includes description information of at least one target part of the object, based on the description information of the target parts, guided images that match the target parts can be determined. For instance, if the description information includes the information that eyes of the object look like the eyes of A (a known object), it would be possible to obtain an image of object A from database as a guided image of the eye part of the object; or if the description information includes the information that nose of the object looks like the nose of B (a known object), it would be possible to obtain an image of object B from database as a guided image of the nose part of the object; or the description information may also include the information that the eyebrows of the object are bushy eyebrows, it would be possible to select an image corresponding to the bushy eyebrows from database and determine this image with bushy eyebrows as a guided image of the eyebrows of the object, and so forth. Therefore, a guided image of at least one part of the object in the first image can be determined based on the captured image information. The database may include at least one image of a plurality of objects, so that it is convenient to determine a corresponding guided image based on the description information.

In some possible implementations, the description information may also include identity information about object A in the first image, and then it is possible to pick out, based on the identity information, from database an image that matches the identity information as a guided image.

With the configuration above, a guided image that matches at least one target part of the object in the first image can be determined from the description information, and using a guided image to reconstruct an image can increase an accuracy of the captured image.

After a guided image is obtained, the guided image can be used to execute reconstruction of the image. In addition to a direct substitution of a guided image into the corresponding target part of the first image, the embodiments of the present disclosure may further obtain reconstructed images by executing substitutions or convolutions after affine transformation on guided images.

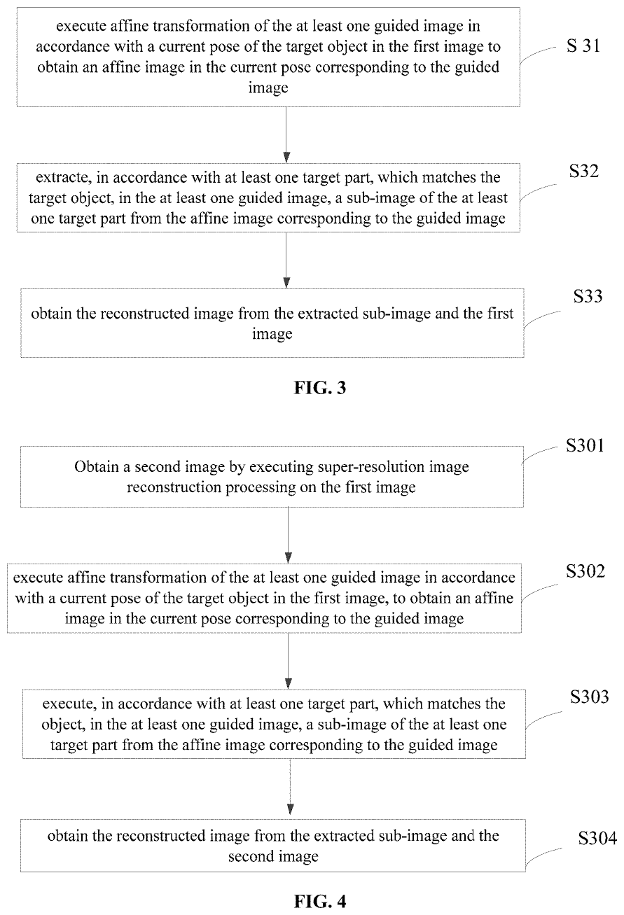

FIG. 3 shows a flowchart of step S30 of an image processing method according to embodiments of the present disclosure. Obtaining a reconstructed image by subjecting the first image to a guide reconstruction based on the at least one guided image of the first image (step S30) may comprise:

S31: executing affine transformation of the at least one guided image in accordance with a current pose of the target object in the first image to obtain an affine image in the current pose corresponding to the guided image;

In some possible implementations, due to a possible difference between the pose of the object in the guided image and the pose of the object in the first image, there is a need to warp guided images in accordance with the first image. That is, the pose of the object in the guided image is made identical with the pose of the target object in the first image.

The embodiments of the present disclosure may perform affine transformation on a guided image by means of affine transformation, and the pose of the object in the guided image after the affine transformation (i.e., an affine image) is identical with the pose of the target object in the first image. For instance, when an object in a first image is a frontal image, all objects in guided images may be adjusted to frontal images by means of affine transformation. The affine transformation may be performed in accordance with the difference between the position of a key point in a first image and the position of a key point in a guided image, so that the guided image and a second image are spatially warped. For example, an affine image that is identical with the pose of the object in the first image is obtainable by deflecting, translating, inpainting, or deleting the guided image. The process of the affine transformation is not specifically limited herein, and may be implemented by existing technical means.

Through the configuration above, at least one affine image (each guided image, after subjected to affine processing, will form an affine image) with the same pose in the first image can be obtained, to implement warp of the affine image in accordance with the first image.

S32: extracting, in accordance with at least one target part, which matches the target object, in the at least one guided image, a sub-image of the at least one target part from the affine image corresponding to the guided image;

Since the resulting guided image is an image that matches at least one target part in the first image, after an affine image corresponding to each guided image is obtained by applying affine transformation, a sub-image of a corresponding guided part (a target part that matches the object) in each guided image is extracted from the affine image based on the guided part, namely, a sub-image of the target part that matches the object in the first image is segmented from the affine image. For example, when a target part, which matches the object, in a guided image is eyes, a sub-image of the eye part may be extracted from the affine image corresponding to the guided image. In this manner, a sub-image which matches at least one part of the object in the first image can be obtained.

S33: obtaining the reconstructed image from the extracted sub-image and the first image.

After a sub-image of at least one target part of the target object is obtained, image reconstruction may be performed using the obtained sub-image and the first image to obtain a reconstructed image.

In some possible implementations, since each sub-image can match at least one target part in the object of the first image, the image of the matched part in the sub-image may be substituted into the corresponding part in the first image. For example, when the eyes in the sub-image match those of the object, the image region of the eyes in the sub-image may be substituted for the eye part in the first image; when the nose in the sub-image matches that of the object, the image region of the nose in the sub-image may be substituted for the nose part in the first image, and so forth. Therefore, images of the parts, which match those of the object, in the extracted sub-images can be substituted for the corresponding parts in the first image, and finally to obtain a reconstructed image.

Alternatively, in some possible implementations, a reconstructed image may also be obtained by subjecting the sub-image and the first image to convolution processing.

Each sub-image and the first image may be input to a convolutional neural network, and are subjected to convolution processing at least once to implement fusion of image features and finally obtain a fused feature. In accordance with this fused feature, a reconstructed image corresponding to the fused feature can be obtained.

By this way, it is possible to improve the resolution of the first image, while obtaining a fine reconstructed image.

In other embodiments of the present disclosure, in order to further improve the image accuracy and definition of a reconstructed image, the first image may be subjected to super-resolution processing to obtain a second image with a higher resolution than that of the first image, and then the second image is used for image reconstruction to obtain a reconstructed image. FIG. 4 shows another flowchart of step S30 of an image processing method according to embodiments of the present disclosure. Obtaining a reconstructed image by subjecting the first image to a guide reconstruction based on the at least one guided image of the first image (step S30) further comprises:

S301: obtaining a second image by executing super-resolution image reconstruction processing on the first image, wherein the resolution of the second image is higher than the resolution of the first image;

In some possible implementations, in the case where a first image is obtained, image super-resolution reconstruction processing of the first image may be executed to obtain a second image with improved image resolution. The super-resolution image reconstruction processing can recover a high-resolution image from a low-resolution image or image sequence. A high-resolution image means that the image has more detailed information and higher image quality.

In one example, executing the super-resolution image reconstruction processing may comprise: executing linear interpolation processing on the first image to increase the scale of the image; and executing convolution processing at least once on the image obtained after the linear interpolation to obtain a super-resolution reconstructed image, namely, a second image. For example, a low-resolution first image may firstly be magnified to a target size (e.g., magnified to 2 times, 3 times, 4 times) through bicubic interpolation processing; the magnified image is still a low-resolution image; thereafter, this magnified image is inputted to a convolutional neural network and subjected to convolution processing at least once. For example, the magnified image is inputted to a three-layer convolutional neural network to reconstruct the Y channel in the YCrCb color space of the image, wherein the neural network may be in the form of (conv1+relu1)−(conv2+relu2)−(conv3+relu3)), where in the first convolutional layer, a convolution has a kernel size of 9×9 (f1×f1), the number of convolution kernels is 64(n1), and the output is composed of 64 feature images; in the second convolutional layer, a convolution has a kernel size of 1×1 (f2×f2), the number of convolution kernels is 32(n2), and the output is composed of 32 feature images; and in the third convolutional layer, a convolution has a kernel size of 5×5 (f3×f3), the number of convolution kernels is 1(n3), and the output is composed of one feature image, which is a final reconstructed high-resolution image, namely, a second image. The structure of the above-mentioned convolutional neural network is only an exemplary explanation, but is not specifically limited in the present disclosure.

In some possible implementations, the super-resolution image reconstruction processing may be implemented by a first neural network that may include an SRCNN network or an SRResNet network. For example, a first image may be inputted to the SRCNN network (a super-resolution convolutional neural network) or the SRResNet network (a super-resolution residual neural network), wherein the network structures of the SRCNN network and the SRResNet network depend upon the structures of existing neural networks, and are not specifically restricted in the present disclosure. A second image can be outputted via the first neural network above, and the obtained second image has a higher resolution than that of the first image.

S302: executing affine transformation of the at least one guided image in accordance with a current pose of the target object in the first image, to obtain an affine image in the current pose corresponding to the guided image;

Similarly as step S31, because the second image has an improved resolution in comparison to the first image, and the pose of the target object in the second image may be distinct from the pose in the guided image, the guided image may be subjected to affine transformation in accordance with the pose of the target object in the second image prior to reconstruction, to obtain an affine image with the same pose of the target object in the second image.

S303: extracting, in accordance with at least one target part, which matches the object, in the at least one guided image, a sub-image of the at least one target part from the affine image corresponding to the guided image;

Similarly as step S32, since a resulting guided image is an image that matches at least one target part in the second image, after an affine image corresponding to each guided image is obtain by affine transformation, a sub-image of a guided part (a target part matching the object) corresponding to each guided image may be extracted from the affine image based on the guided part, that is, a sub-image of the target part that matches the object in the first image is segmented from the affine image. For example, in the case where a target part, which matches the object, in a guided image is eyes, a sub-image of the eye part may be extracted from the affine image corresponding to the guided image. In this manner, a sub-image, which matches at least one part of the object in the first image can be obtained.

S304: obtaining the reconstructed image from the extracted sub-image and the second image.

After a sub-image of at least one target part of the target object is obtained, image reconstruction may be performed using the obtained sub-image and the second image, to obtain a reconstructed image.

In some possible implementations, since each sub-image can match at least one target part in the object in the second image, the image of the matched part in the sub-image may be substituted into the corresponding part in the second image. For example, when the eyes in the sub-image match those of the object, the image region of the eyes in the sub-image can be substituted for the eye part in the second image; when the nose in the sub-image matches that of the object, the image region of the nose in the sub-image can be substituted for the nose part in the second image, and so forth. Therefore, images of the parts, which match those of the object, in the extracted sub-images can be substituted for the corresponding parts in the second image, and finally to obtain a reconstructed image.

Alternatively, in some possible implementations, a reconstructed image may also be obtained by subjecting the sub-image and the second image to convolution processing.

Each sub-image and the second image may be inputted to a convolutional neural network, and are subjected to convolution processing at least once to implement fusion of image features and finally obtain a fused feature. In accordance with this fused feature, a reconstructed image corresponding to the fused feature can be obtained.

In this manner, by the super-resolution reconstruction processing, it is possible to further improve the resolution of the first image, and obtain a finer reconstructed image at the same time.

After the reconstructed image of the first image is obtained, identity recognition of the object in the image may further be executed in accordance with this reconstructed image. Identity database may include identity information of a plurality of objects, for example, the identity database may also include facial images and information such as name, age, and occupation of the object, etc. Correspondingly, the reconstructed image can be compared with each facial image, and if a facial image with the highest similarity is obtained and the similarity is higher than the threshold, this facial image can be determined as a facial image of the object that matches the reconstructed image, so that the identity information of the object in the reconstructed image can be determined. Due to higher quality such as resolution and definition of a reconstructed image, the accuracy of the obtained identity information is also improved relatively.

To explain the process of the embodiments of the present disclosure more clearly, the process of the image processing method will be exemplified below.

FIG. 5 shows a schematic diagram for the process of an image processing method according to embodiments of the present disclosure.

A first image F1 (LR low-resolution image) is obtained. The first image F1 has a low resolution and a low image quality. The first image F1 is inputted to neural network A (such as an SRResNet network) and subjected to super-resolution image reconstruction processing to obtain a second image F2 (a coarse Super-Resolution (SR) image).

After the second image F2 is obtained, reconstruction of the image may be implemented using this second image. Guided images F3 for the first image may be obtained, e.g., the guided images F3 can be obtained based on the description information of the first image F1. The guided images F3 are subjected to affine transformation (warped) in accordance with the pose of the object in the second image F2 to obtain affine images F4. Afterwards, in accordance with the parts corresponding to the guided images, sub-images F5 of the corresponding parts can be extracted from the affine images.

Thereafter, a reconstructed image is obtained in accordance with those sub-images F5 and the second image F2, wherein the sub-images F5 and the second image F2 may be subjected to convolution processing to obtain a fused feature. Based on the fused feature, a final reconstructed image F6 (a fine Super-Resolution (SR) image) is obtained.

The foregoing just exemplarily illustrates the process of image processing, but is not specifically limited in the present disclosure.

Additionally, in the embodiments of the present disclosure, the image processing method according to the embodiments of the present disclosure may be implemented by a neural network. For example, in step S201, the first neural network (e.g., an SRCNN or SRResNet network) may be utilized to realize super-resolution reconstruction processing, and the second neural network (a convolutional neural network CNN) may be utilized to realize image reconstruction processing (step S30), wherein the affine transformation of images is implementable by corresponding algorithms.

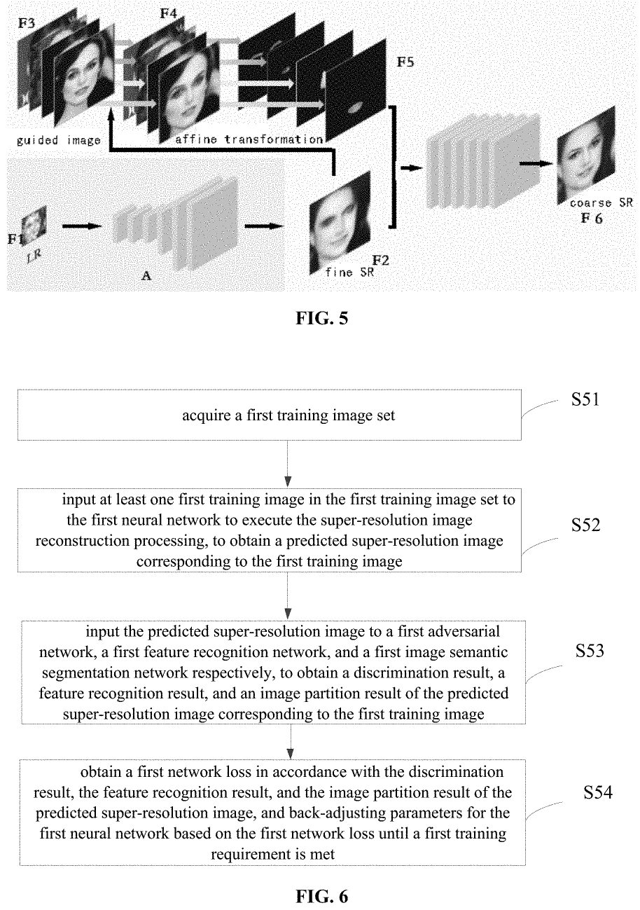

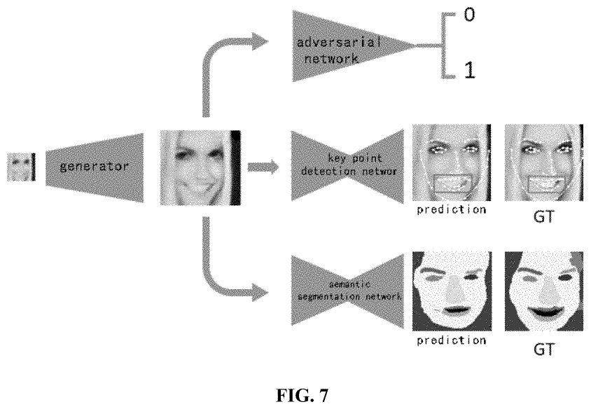

FIG. 6 shows a flowchart of training a first neural network according to embodiments of the present disclosure. FIG. 7 shows a schematic structural diagram for training a first neural network according to embodiments of the present disclosure. The process of training the neural network may comprise:

S51: acquiring a first training image set, wherein the first training image set includes a plurality of first training images, and first surveillance data corresponding to the first training images;

In some possible implementations, a training image set may include a plurality of first training images, which may be lower-resolution images, for example, images captured in a dim environment, shaking conditions, or other conditions that affect image quality, or images with reduced image resolution as a result of noise mixed in the images. Accordingly, the first training image set may further include surveillance data corresponding to all first training images, and the first surveillance data in the embodiments of the present disclosure can be determined by parameters for loss functions. The first surveillance data may include, for example, first standard images (fine images) corresponding to the first training images, first standard features (authentic recognition feature of position of each key point) of the first standard images, first standard segmentation results (authentic segmentation result of each part), and the like, which are not illustrated here one by one.

In most of available methods for reconstructing lower pixel human faces (such as 16*16), impacts of severe image degradation, such as noise and blur, are rarely considered. Once noise and blur are mixed in, the original model is no longer applicable. When the degradation becomes very severe, even if noise and blur retraining models were added, it would still be impossible to recover fine facial features. When training the first neural network or the second neural network described below, the present disclosure may use images with noise mixed in or severely degraded images as training images, thereby improving the accuracy of the neural network.

S52: inputting at least one first training image in the first training image set to the first neural network to execute the super-resolution image reconstruction processing, to obtain a predicted super-resolution image corresponding to the first training image;

When training the first neural network, the images in the first training image set may be inputted together or in batches to the first neural network, to obtain predicted super-resolution images, which have been subjected to super-resolution reconstruction processing, corresponding to all first training images, respectively.

S53: inputting the predicted super-resolution image to a first adversarial network, a first feature recognition network, and a first image semantic segmentation network respectively, to obtain a discrimination result, a feature recognition result, and an image segmentation result of the predicted super-resolution image corresponding to the first training image;

As shown in FIG. 7, the first neural network may be trained with the aid of adversarial network (Discriminator), key point detection network (FAN), and semantic segmentation network (parsing). A generator is equivalent to the first neural network in the embodiments of the present disclosure. The following is a case study of the generator used as a first neural network of the network part that executes super-resolution image reconstruction processing.

The predicted super-resolution image outputted from the generator is inputted to the above-mentioned adversarial network, feature recognition network, and image semantic segmentation network to obtain a discrimination result, a feature recognition result, and an image segmentation result of the predicted super-resolution image corresponding to the training image. The discrimination result indicates whether the first adversarial network can discriminate the authenticity of the predicted super-resolution image and the labeled image. The feature recognition result includes recognition results of positions of key points, and the image segmentation result includes regions where parts of the object are located.

S54: obtaining a first network loss in accordance with the discrimination result, the feature recognition result, and the image segmentation result of the predicted super-resolution image, and back-adjusting parameters for the first neural network based on the first network loss until a first training requirement is met.

The first training requirement is that the first network loss is less than or equal to the first loss threshold. That is, when the first network loss obtained is less than the first loss threshold, the training of the first neural network is stopped, and the neural network obtained at this time has a high super-resolution processing accuracy. The first loss threshold may be a value less than 1, e.g., 0.1, but this value is not a specific limitation in the present disclosure.

In some possible implementations, the adversarial loss may be obtained based on the discrimination result of the predicted super-resolution image; the segmentation loss may be obtained in accordance with the image segmentation result; the heat map loss may be obtained in accordance with the obtained feature recognition result; and the corresponding pixel loss and processed perceptual loss may be obtained in accordance with the predicted super-resolution image obtained.

To be specific, the first adversarial loss may be obtained based on the discrimination result of the predicted super-resolution image, and the discrimination result of the first standard image in the first surveillance data by the first adversarial network. The first adversarial loss may be determined from the discrimination result of the predicted super-resolution image corresponding to each first training image in the first training image set, and the discrimination result of the first standard image, which corresponds to the first training image, in the first surveillance data by the first adversarial network. The expression of the adversarial loss function is:

$${l}_{adv} = {E}_{\hat{I} ∼ {P}_{g}} [ D ( \hat{I} ) ] - {E}_{{I}^{HR} ∼ {P}_{r}} [ D ( {I}^{HR} ) ] + λ {E}_{\hat{I} ∼ {P}_{\hat{I}}} [ {( {‖ {∇}_{\hat{I}} D ( \hat{I} ) ‖}_{2} - 1 )}^{2} ] ; \qquad ( 1 )$$

wherein, l_{adv} represents a first adversarial loss;

$${E}_{\hat{I} ∼ {P}_{g}} [ D ( \hat{I} ) ]$$

represents a desired distribution of a discrimination result D(Î) of a predicted super-resolution image Î; P_{g} represents a sample distribution of a predicted super-resolution image;

$${E}_{{I}^{HR} ∼ {P}_{r}} [ D ( {I}^{HR} ) ]$$

represents a desired distribution of a discrimination result D(I^{HR}) of a first standard image I^{HR}, which corresponds to a first training image, in the first surveillance data; Pᵣ represents a sample distribution of a standard image; ∇ represents a gradient function; ∥ ∥₂ represents 2 norm; and P_{Î} represents a sample distribution obtained by uniformly sampling in a straight line formed by P_{g} and Pᵣ.

Based on the aforementioned expression of the adversarial loss function, a first adversarial loss corresponding to the predicted super-resolution image can be obtained.

Besides, a first pixel loss may be determined based on the predicted super-resolution image corresponding to the first training image, and the first standard image, which corresponds to the first training image, in the first surveillance data. The expression of the pixel loss function is:

lₚᵢₓₑₗ=∥I^{HI}−I^{SR}∥²; (2)

wherein, lₚᵢₓₑₗ represents a first pixel loss; I^{HR} represents a first standard image corresponding to a first training image; I^{SR} represents a predicted super-resolution image (identical with Î above) corresponding to a first training image; and ∥ ∥² represents a square of norm.

According to the above expression of the pixel loss function, the first pixel loss corresponding to the predicted super-resolution image can be obtained.

Additionally, a first perceptual loss may be obtained based on the nonlinear processing of the predicted super-resolution image and the first standard image. The expression of the perceptual loss function is:

$${l}_{per} = \frac{1}{{C}_{k} {W}_{k} {H}_{k}} {‖ {φ}_{k} ( {I}^{HR} ) - {φ}_{k} ( {I}^{SR} ) ‖}_{2}^{2} ; \qquad ( 3 )$$

wherein, lₚₑᵣ represents a first perceptual loss; Cₖ represents the number of channels of a predicted super-resolution image and a first standard image; Wₖ represents a width of a predicted super-resolution image and a first standard image; Hₖ represents a height of a predicted super-resolution image and a first standard image; and φₖ represents a nonlinear conversion function for extracting image features (e.g., using conv5-3 in the VGG network, from simonyan and zisserman, 2014).

A first perceptual loss corresponding to a predicted super-resolution image is obtainable from the above expression of the perceptual loss function.

In addition, a first heat map loss is obtained based on the feature recognition results of the predicted super-resolution image corresponding to the training image and the first standard feature in the first surveillance data, and the expression of the heat map loss function is:

$${l}_{hea} = \frac{1}{N} {\sum }_{n = 1}^{N} {\sum }_{ij} {( {\tilde{M}}_{i , j}^{n} - {\hat{M}}_{i , j}^{n} )}^{2} ; \qquad ( 4 )$$

wherein, lₕₑₐ represents a first heat map loss corresponding to a predicted super-resolution image; N represents the number of mark points (such as key points) of a predicted super-resolution image and a first standard image; n is an integer variable from 1 to N; i represents the number of rows; j represents the number of columns; \tilde{M}_{i,j}ⁿ represents a feature recognition result (heat map) of row i, column j of a predicted super-resolution image of the n^{th} label, and \hat{M}_{i,j}ⁿ represents a feature recognition result (heat map) of row i, column j of a first standard image of the n^{th} label.

A first heat map loss corresponding to a predicted super-resolution image is obtainable from the above expression of the heat map loss function.

In addition, a first segmentation loss is obtained based on the image segmentation result of the predicted super-resolution image corresponding to the training image and the first standard segmentation result in the first surveillance data, and the expression of the segmentation loss function is:

$${l}_{par} = \frac{1}{M} {\sum }_{m = 1}^{M} {( {\tilde{Q}}^{m} - {\hat{Q}}^{m} )}^{2} ; \qquad ( 5 )$$

wherein, lₚₐᵣ represents a first segmentation loss of a predicted super-resolution image; M represents quantity of segmentation regions of a predicted super-resolution image and a first standard image; m is an integer variable from 1 to M; \tilde{Q}^{m} represents the m^{th} segmentation region of a predicted super-resolution image; and \hat{Q}^{m} represents the m^{th} image segmentation region of a first standard image.

A first segmentation loss corresponding to the predicted super-resolution image is obtainable from the above expression of the segmentation loss function.

A first network loss is obtained by a weighted sum of the above first adversarial loss, first pixel loss, first perpetual loss, first heat map loss, and first segmentation loss. The expression of the first network loss is:

l_{coarse}=αl_{adv}+βl_{adv}+γlₚₑᵣ+δlₕₑₐ+∂lₚₐᵣ; (6)

wherein, l_{coarse} represents a first network loss; and α, β, γ, δ and ∂ represent weights of a first adversarial loss, a first pixel loss, a first perpetual loss, a first heat map loss, and a first segmentation loss, respectively. The value of the weight may be preset, which is not specifically limited in the present disclosure, for example, the sum of all weights may be 1, or at least one of the weights is greater than 1.

A first network loss of the first neural network can be obtained in the above manner. If the first network loss is greater than the first loss threshold, it is not determined the first training requirement is met. Then it is possible to back-adjust network parameters (e.g., convolution parameter) for the first neural network, and continue to execute the super-resolution image processing on the training image set by the first neural network with adjusted parameters, until the obtained first network loss is less than or equal to the first loss threshold. In this instance, it is not determined the first training requirement is met, and the training of the neural network is terminated.

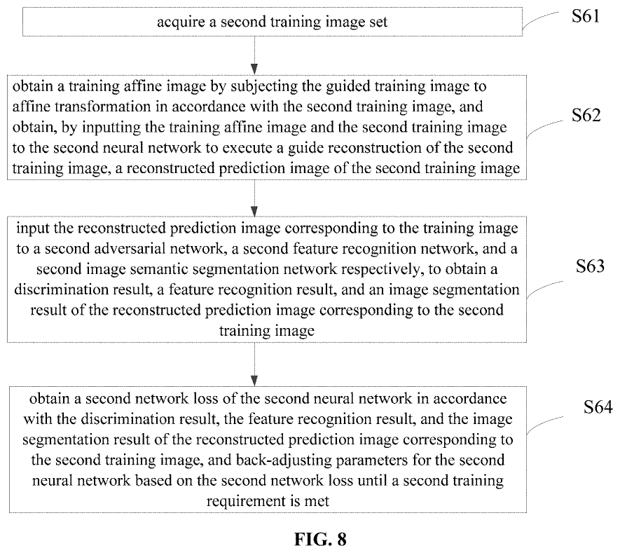

The foregoing is a process of training the first neural network. In the embodiments of the present disclosure, it is also possible to execute the image reconstruction process in step S30 via a second neural network. For example, the second neural network may be a convolutional neural network. FIG. 8 shows a flowchart of training a second neural network according to embodiments of the present disclosure. The process of training a second neural network may comprise:

S61: acquiring a second training image set, wherein the second training image set includes a plurality of second training images, second surveillance data and guided training images corresponding to the second training images;

In some possible implementations, the second training images in the second training image set may be predicted super-resolution images formed by prediction of the aforesaid first neural network, or relatively lower-resolution images obtained by other approaches, or images in which noise is mixed, which are not specifically limited in the present disclosure.

When training of the second neural network, each training image may be configured with at least one guided training image that includes guide information of the corresponding second training image, such as an image of at least one part. Guided training images are also high-resolution and fine images. Each of the second training images may include different numbers of guided training images, and all guided training images may correspond to different guided parts, which are not specifically restricted in the present disclosure.

The second surveillance data may also be determined by parameters for loss functions. The second surveillance data may include second standard images (fine images) corresponding to the second training images, second standard features (authentic recognition feature of position of each key point) of the second standard images, second standard segmentation results (authentic segmentation result of each part), or may include discrimination results (which are outputted from the adversarial network), feature recognition results, segmentation results, etc. of parts in a second standard image, which are not illustrated here one by one.

In case where the second training image is a predicted super-resolution image outputted from the first neural network, the first standard image and the second standard image are the same; the first standard segmentation result and the second standard segmentation result are the same; and the first feature result and the second feature result are the same.

S62: obtaining a training affine image by subjecting the guided training image to affine transformation in accordance with the second training image, and obtaining, by inputting the training affine image and the second training image to the second neural network to execute a guide reconstruction of the second training image, a reconstructed prediction image of the second training image;

As set out above, each of the second training images may have at least one corresponding guided image. In accordance with the pose of the object in the second training image, a guided training image may be subjected to affine transformation (warped) to obtain at least one training affine image. The at least one training affine image corresponding to the second training image and the second training image may be inputted to a second neural network to obtain a corresponding reconstructed prediction image.

S63: inputting the reconstructed prediction image corresponding to the training image to a second adversarial network, a second feature recognition network, and a second image semantic segmentation network respectively, to obtain a discrimination result, a feature recognition result, and an image segmentation result of the reconstructed prediction image corresponding to the second training image;

Similarly, referring to FIG. 7, a second neural network may be trained using the construction of FIG. 7. Now the generator can represent a second neural network. The reconstructed prediction image corresponding to the second training image may also be inputted to an adversarial network, a feature recognition network, and an image semantic segmentation network respectively, to obtain a discrimination result, a feature recognition result, and an image segmentation result of the reconstructed prediction image. The discrimination result indicates a discrimination result of the authenticity of the reconstructed prediction image and the standard image. The feature recognition result includes recognition results of positions of key points in the reconstructed prediction image, and the image segmentation result includes segmentation result of region where each part of the object is located in the reconstructed prediction image.

S64: obtaining a second network loss of the second neural network in accordance with the discrimination result, the feature recognition result, and the image segmentation result of the reconstructed prediction image corresponding to the second training image, and back-adjusting parameters for the second neural network based on the second network loss until a second training requirement is met.

In some possible implementations, a second network loss may be a weighted sum of a global loss and a local loss, namely, the global loss and the local loss may be obtained based on the discrimination result, the feature recognition result, and the image segmentation result of the reconstructed prediction image corresponding to the training image, and the second network loss is obtained by a weighted sum of the global loss and the local loss.

The global loss may be a weighted sum of an adversarial loss, a pixel loss, a perpetual loss, a segmentation loss, and a heat map loss of the reconstructed prediction image.

As with the approach to acquire the first adversarial loss, referring to the adversarial loss function, a second adversarial loss may be obtained based on a discrimination result of the reconstructed prediction image and a discrimination result of a second standard image from the second surveillance data by the adversarial network; as with the approach to acquire the first pixel loss, referring to the pixel loss function, a second pixel loss may be determined from a reconstructed prediction image corresponding to the second training image and a second standard image corresponding to the second training image; as with the approach to acquire the first perpetual loss, referring to the perpetual loss function, a second perpetual loss may be determined by nonlinearly processing the reconstructed prediction image and the second standard image corresponding to the second training image; as with the approach to acquire the first heat map loss, referring to the heat map loss function, a second heat map loss may be obtained based on the feature recognition result of a reconstructed prediction image corresponding to the second training image and a second standard feature in the second surveillance data; as with the approach to acquire the first segmentation loss, referring to the segmentation loss function, a second segmentation loss may be obtained based on the image segmentation result of a reconstructed prediction image corresponding to the second training image and a second standard segmentation result from the second surveillance data; and the global loss is obtained by a weighted sum of the second adversarial loss, the second pixel loss, the second perpetual loss, the second heat map loss, and the second segmentation loss.

The expression of the global loss may be:

l_{global}=αl_{adv1}+βlₚᵢₓₑₗ₁+γlₚₑᵣ₁+δlₕₑₐ₁+∂lₚₐᵣ₁; (7)

wherein, l_{global} represents a global loss; l_{adv1} represents a second adversarial loss; lₚᵢₓₑₗ₁ represents a second pixel loss; lₚₑᵣ₁ represents a second perpetual loss; lₕₑₐ₁ represents a second heat map loss; lₚₐᵣ₁ represents a second segmentation loss; and α, β, γ, δ and ∂ represent weights of losses, respectively.

Besides, an approach to determine a local loss of the second neural network may comprise:

extracting a part sub-image (e.g., a sub-image of a part such as eyes, nose, mouth, eyebrow and face) corresponding to at least one part from the reconstructed prediction image; and inputting the part sub-image of the at least one part to an adversarial network, a feature recognition network, and an image semantic segmentation network respectively, to obtain a discrimination result, a feature recognition result, and an image segmentation result of the part sub-image of the at least one part;

determining a third adversarial loss of the at least one part from the discrimination result of the part sub-image of the at least one part, and the discrimination result of the part sub-image of the at least one part from the second standard image corresponding to the second training image by the second adversarial network;

obtaining a third heat map loss of the at least one part based on the feature recognition result of the part sub-image of the at least one part and the standard feature of the corresponding part in the second surveillance data;

obtaining a third segmentation loss of the at least one part based on the image segmentation result of the part sub-image of the at least one part and the standard segmentation result of the at least one part in the second surveillance data; and

obtaining the local loss of the network by a weighted sum of the third adversarial network loss, the third heat map loss, and the third segmentation loss of the at least one part.

As with the approaches to obtain the losses above, local losses of the parts may be determined by weighted sum of the third adversarial network losses, the third pixel losses, and the third perceptual losses of the sub-images of the parts in a reconstructed prediction image, for example,

l_{eyebrow}=l_{adv}+lₚᵢₓₑₗ+lₚₐᵣ

l_{eye}=l_{adv}+lₚᵢₓₑₗ+lₚₐᵣ

lₙₒₛₑ=l_{adv}+lₚᵢₓₑₗ+lₚₐᵣ

lₘₒᵤₜₕ=l_{adv}+lₚᵢₓₑₗ+lₚₐᵣ (8)

a local loss of eyebrows l_{eyebrow} may be obtained by a sum of the third adversarial loss, the third perceptual loss, and the third pixel loss of the eyebrows; a local loss of eyes l_{eye} may be obtained by a sum of the third adversarial loss, the third perceptual loss, and the third pixel loss of the eyes; a local loss of nose lₙₒₛₑ may be obtained by a sum of the third adversarial loss, the third perceptual loss, and the third pixel loss of the nose; a local loss of mouth lₘₒᵤₜₕ may be obtained by a sum of the third adversarial loss, the third perceptual loss, and the third pixel loss of the mouth, and so forth to obtain local images of the parts in the reconstructed image, and then to obtain the local loss l_{local} of the second neural network by a sum of the local losses of the parts, namely,

l_{local}=l_{eyebrow}+l_{eye}+lₙₒₛₑ+lₘₒᵤₜₕ (9).

After a sum of the local loss and the global loss is obtained, the second network loss (a weighted sum of the global loss and the local loss) will be obtained, i.e., l_{fine}=l_{global}+l_{local}, wherein l_{fine} represents a second network loss.

A second network loss of the second neural network can be obtained in the above manner. If the second network loss is greater than the second loss threshold, it is not determined the second training requirement is met. Then it is possible to back-adjust network parameters (e.g., convolution parameter) for the second neural network, and continue to execute the super-resolution image processing on the training image set by the second neural network with adjusted parameters, until the obtained second network loss is less than or equal to the second loss threshold. In this instance, it is determined the second training requirement is met, and the training of the second neural network is terminated. The second neural network obtained thereby can be used to obtain a reconstructed prediction image precisely.

Altogether, the embodiments of the present disclosure can execute reconstruction of low-resolution images using guided images to obtain fine reconstructed images. This method enables the resolution of images to be improved easily to obtain fine images.

A person skilled in the art may understand that, in the foregoing method in specific implementations, the sequence of describing the steps does not means a strict execution sequence to impose any limitation on the implementation process, and a specific execution sequence of the steps should depend on functions and possible internal logics of the steps.

In addition, the embodiments of the present disclosure further provide image processing apparatuses and electronic devices, in which the above-mentioned image processing method is applied.

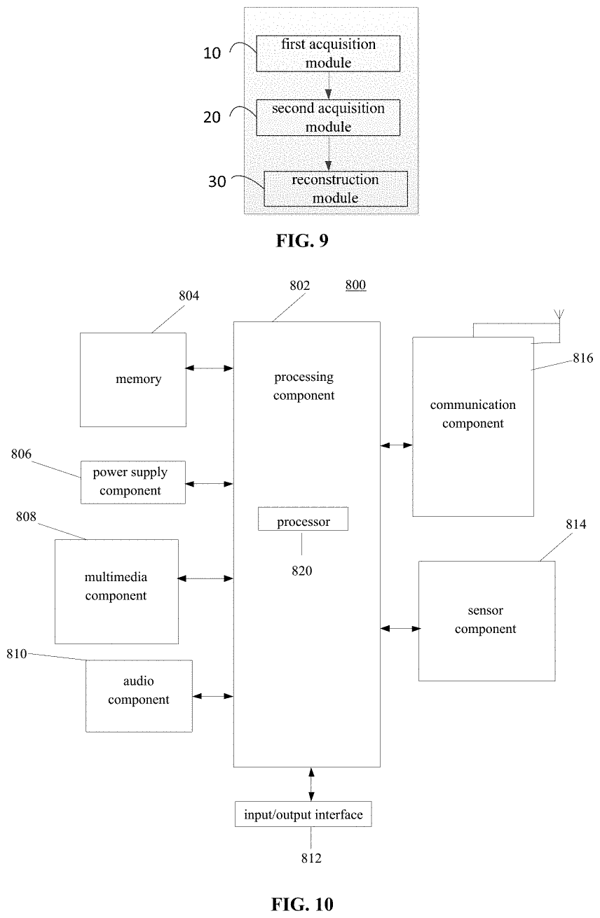

FIG. 9 shows a block diagram for an image processing apparatus according to embodiments of the present disclosure, wherein the apparatus comprises:

a first acquisition module 10 configured to acquire a first image;

a second acquisition module 20 configured to acquire at least one guided image of the first image, wherein the guided image includes guide information of a target object in the first image; and

a reconstruction module 30, configured to obtain a reconstructed image by subjecting the first image to a guide reconstruction based on the at least one guided image of the first image.

In some possible implementations, the second acquisition module is further configured to acquire description information of the first image; and

to determine a guided image that matches at least one target part of the target object based on the description information of the first image.

In some possible implementations, the reconstruction module comprises:

an affine unit configured to execute affine transformation of the at least one guided image in accordance with a current pose of the target object in the first image to obtain an affine image in the current pose corresponding to the guided image;

an extraction unit configured to extract, in accordance with at least one target part, which matches the target object, in the at least one guided image, a sub-image of the at least one target part from the affine image corresponding to the guided image; and

a reconstruction unit configured to obtain the reconstructed image from the extracted sub-image and the first image.

In some possible implementations, the reconstruction unit is further configured to obtain the reconstructed image by replacing a part, which corresponds to the target part in the sub-image, in the first image with the extracted sub-image, or

to obtain the reconstructed image by subjecting the sub-image and the first image to convolution processing.

In some possible implementations, the reconstruction module comprises:

a super-resolution unit configured to execute super-resolution image reconstruction processing of the first image to obtain a second image, wherein the resolution of the second image is higher than the resolution of the first image;

an affine unit configured to execute affine transformation of the at least one guided image in accordance with a current pose of the target object in the second image to obtain an affine image in the current pose corresponding to the guided image;

an extraction unit configured to extract, in accordance with at least one target part, which matches the object, in the at least one guided image, a sub-image of the at least one target part from the affine image corresponding to the guided image; and

a reconstruction unit configured to obtain a reconstructed image based on the extracted sub-image and the second image.

In some possible implementations, the reconstruction unit is further configured to obtain the reconstructed image by replacing a part, which corresponds to the target part in the sub-image, in the second image with the extracted sub-image, or

to obtain the reconstructed image by subjecting the sub-image and the second image to convolution processing.

In some possible implementations, the apparatus further comprises:

an identity recognition unit, configured to execute identity recognition with the reconstructed image to determine identity information that matches the object.

In some possible implementations, the super-resolution unit comprises a first neural network, wherein the first neural network is configured to execute super-resolution image reconstruction processing of the first image; and

the apparatus further comprises a first training module, configured to train the first neural network, wherein the step of training the first neural network comprises:

acquiring a first training image set, wherein the first training image set includes a plurality of first training images, and first surveillance data corresponding to the first training images;

inputting at least one first training image in the first training image set to the first neural network to execute the super-resolution image reconstruction processing, to obtain a predicted super-resolution image corresponding to the first training image;

inputting the predicted super-resolution image to a first adversarial network, a first feature recognition network, and a first image semantic segmentation network respectively, to obtain a discrimination result, a feature recognition result and an image segmentation result of the predicted super-resolution image; and

obtaining a first network loss in accordance with the discrimination result, the feature recognition result, and the image segmentation result of the predicted super-resolution image, and back-adjusting parameters for the first neural network based on the first network loss until a first training requirement is met.

In some possible implementations, the first training module is configured to determine a first pixel loss from a predicted super-resolution image corresponding to the first training image, and from a first standard image, which corresponds to the first training image, in the first surveillance data;

obtaining a first adversarial loss based on the discrimination result of the predicted super-resolution image, and the discrimination result of the first standard image by the first adversarial network;

determining a first perceptual loss by nonlinearly processing the predicted super-resolution image and the first standard image;

obtaining a first heat map loss based on the feature recognition result of the predicted super-resolution image and a first standard feature in the first surveillance data;

obtaining a first segmentation loss based on the image segmentation result of the predicted super-resolution image and a first standard segmentation result, which corresponds to a first training sample, in the first surveillance data; and

obtaining the first network loss by a weighted sum of the first adversarial loss, the first pixel loss, the first perceptual loss, the first heat map loss, and the first segmentation loss.

In some possible implementations, the reconstruction module comprises a second neural network, wherein the second neural network is configured to execute the guide reconstruction to obtain the reconstructed image; and

the apparatus further comprises a second training module configured to train the second neural network, wherein, the step of training the second neural network comprises:

acquiring a second training image set, wherein the second training image set includes second training images, second surveillance data and guided training images corresponding to the second training images;

obtaining a training affine image by subjecting the guided training image to affine transformation in accordance with the second training image, and obtaining, by inputting the training affine image and the second training image to the second neural network to execute guide reconstruction of the second training image, a reconstructed prediction image of the second training image;

inputting the reconstructed prediction image to a second adversarial network, a second feature recognition network, and a second image semantic segmentation network respectively, to obtain a discrimination result, a feature recognition result, and an image segmentation result of the reconstructed prediction image; and

obtaining a second network loss of the second neural network in accordance with the discrimination result, the feature recognition result, and the image segmentation result of the reconstructed prediction image, and back-adjusting parameters for the second neural network based on the second network loss until a second training requirement is met.

In some possible implementations, the second training module is further configured to obtain a global loss and a local loss in accordance with the discrimination result, the feature recognition result, and the image segmentation result of a reconstructed prediction image corresponding to the second training image; and

to obtain the second network loss by a weighted sum of the global loss and the local loss.

In some possible implementations, the second training module is further configured to determine a second pixel loss from a reconstructed prediction image corresponding to the second training image, and from a second standard image, which corresponds to the second training image, in the second surveillance data;

to obtain a second adversarial loss based on the discrimination result of the reconstructed prediction image, and the discrimination result of the second standard image by the second adversarial network;

to determine a second perceptual loss by nonlinearly processing the reconstructed prediction image and the second standard image;

to obtain a second heat map loss based on the feature recognition result of the reconstructed prediction image and a second standard feature in the second surveillance data;

to obtain a second segmentation loss based on the image segmentation result of the reconstructed prediction image and a second standard segmentation result in the second surveillance data; and

to obtain the global loss by a weighted sum of the second adversarial loss, the second pixel loss, the second perceptual loss, the second heat map loss, and the second segmentation loss.

In some possible implementations, the second training module is further configured to:

extract a part sub-image of at least one part in the reconstructed prediction image, and input the part sub-image of the at least one part to an adversarial network, a feature recognition network, and an image semantic segmentation network respectively, to obtain a discrimination result, a feature recognition result, and an image segmentation result of the part sub-image of the at least one part;

determine a third adversarial loss of the at least one part from the discrimination result of the part sub-image of the at least one part, and from the discrimination result of the part sub-image of the at least one part in the second standard image by the second adversarial network;

obtain a third heat map loss based on the feature recognition result of the part sub-image of the at least one part and a standard feature of the at least one part in the second surveillance data;

obtain a third segmentation loss of the at least one part based on the image segmentation result of the part sub-image of the at least one part and the standard segmentation result of the at least one part in the second surveillance data; and

obtain a local loss of the network by a weighted sum of the third adversarial loss, the third heat map loss, and the third segmentation loss of the at least one part.

In some embodiments, functions of or modules included in the apparatus provided in the embodiments of the present disclosure may be configured to execute the method described in the foregoing method embodiments. For specific implementation of the apparatus, reference may be made to descriptions of the foregoing method embodiments. For brevity, details are not described here again.

The embodiments of the present disclosure further propose a computer readable storage medium having computer program instructions stored thereon, wherein the computer program instructions, when executed by a processor, carry out the method. The computer readable storage medium may be a volatile computer readable storage medium or a non-volatile computer readable storage medium.

The embodiments of the present disclosure further propose an electronic device, comprising: a processor; and a memory configured to store processor-executable instructions; wherein the processor is configured to carry out the above method.

The electronic device may be provided as a terminal, a server, or a device in another form.

FIG. 10 shows a block diagram for an electronic device according to embodiments of the present disclosure. For example, electronic device 800 may be a mobile phone, a computer, a digital broadcasting terminal, a messaging device, a game console, a tablet device, medical equipment, fitness equipment, a personal digital assistant, and other terminals.

Referring to FIG. 10, electronic device 800 may include one or more of the following components: a processing component 802, a memory 804, a power component 806, a multimedia component 808, an audio component 810, an input/output (I/O) interface 812, a sensor component 814, and a communication component 816.

Processing component 802 usually controls overall operations of electronic device 800, such as the operations associated with display, telephone calls, data communications, camera operations, and recording operations. Processing component 802 can include one or more processors 820 configured to execute instructions to perform all or part of the steps included in the above-described methods. In some embodiments, processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic device 800. Examples of such data include instructions for any applications or methods performed by electronic device 800, contact data, phonebook data, messages, pictures, video, etc. Memory 804 may be implemented using any type of volatile or non-volatile storage devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic device 800. Power component 806 may include a power management system, one or more power sources, and any other components associated with the generation, management, and distribution of power for electronic device 800.

Multimedia component 808 includes a screen providing an output interface between electronic device 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 may include a front camera and/or a rear camera.

The front camera and/or the rear camera may receive an external multimedia datum while electronic device 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic device 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 may include one or more sensors configured to provide status assessments of various aspects for electronic device 800. For example, sensor component 814 may detect at least one of an open/closed status of electronic device 800, relative positioning of components, e.g., the display and the keypad, of electronic device 800, a change in position of electronic device 800 or a component of electronic device 800, a presence or absence of user contact with electronic device 800, an orientation or an acceleration/deceleration of electronic device 800, and a change in temperature of electronic device 800. Sensor component 814 may include a proximity sensor configured to detect the presence of nearby objects without any physical contact. Sensor component 814 may also include a optical sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic device 800 and other devices. Electronic device 800 can access a wireless network based on a communication standard, such as WiFi, 2G, or 3G, or a combination thereof. In an exemplary embodiment, communication component 816 receives a broadcast signal or broadcast associated information from an external broadcast management system via a broadcast channel. In an exemplary embodiment, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-volatile computer readable storage medium such as memory 804 including computer program instructions executable by processor 820 of electronic device 800, for performing the above-described methods.

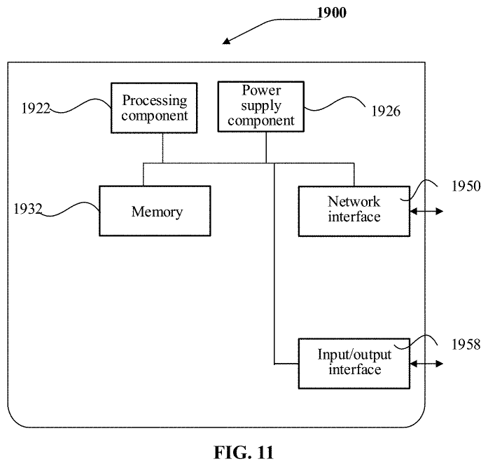

FIG. 11 is another block diagram showing an electronic device according to embodiments of the present disclosure. For example, the electronic device 1900 may be provided as a server. Referring to FIG. 11, the electronic device 1900 includes a processing component 1922, which further includes one or more processors, and a memory resource represented by a memory 1932 configured to store instructions such as application programs executable for the processing component 1922. The application programs stored in the memory 1932 may include one or more modules, each of which corresponds to a set of instructions. In addition, the processing component 1922 is configured to execute the instructions to execute the abovementioned methods.

The electronic device 1900 may further include a power component 1926 configured to execute power management of the electronic device 1900, a wired or wireless network interface 1950 configured to connect the electronic device 1900 to a network, and an Input/Output (I/O) interface 1958. The electronic device 1900 may be operated on the basis of an operating system stored in the memory 1932, such as Windows Server™, Mac OS X™, Unix™, Linux™ or FreeBSD™.

In exemplary embodiments, there is also provided a nonvolatile computer readable storage medium such as memory 1932 including computer program instructions executable by processing component 1922 of the electronic device 1900, for performing the above-described methods.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, the electronic circuitry (for example, programmable logic circuitry, field-programmable gate arrays (FPGA), or programmable logic arrays (PLA)) may be personalized by utilizing state information of the computer readable program instructions, and may execute the computer readable program instructions, in order to perform aspects of the present disclosure.

Aspects of the present invention are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/actions specified in one or more blocks in the flowchart and/or block diagram. These computer readable program instructions may also be stored in a computer readable storage medium, and the instructions can direct a computer, a programmable data processing apparatus, and/or other devices to function in a particular manner, such that the computer readable storage medium having instructions stored therein comprises an article of manufacture including instructions which implement aspects of the functions/actions specified in one or more blocks in the flowchart and/or block diagram.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in one or more blocks in the flowchart and/or block diagram.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, program segment, or portion of instruction, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

All embodiments of the present disclosure are described above. The foregoing descriptions are exemplary but not exhaustive, and are not limited to all embodiments disclosed above. For a person skilled in the art, many modifications and variations are all obvious without departing from the scope and spirit of all the described embodiments. The terms used in the specification are intended to best explain the principles of all embodiments, practical applications, or technical improvements to the technologies in the market, or to enable others of ordinary skill in the art to understand the embodiments disclosed in the specification.

What is claimed is:

1. An image processing method, comprising:
acquiring a first image;
acquiring at least one guided image of the first image, the guided image including guide information of a target object in the first image; and
obtaining a reconstructed image by subjecting the first image to a guide reconstruction based on the at least one guided image of the first image.

2. The method according to claim 1, wherein, acquiring the at least one guided image of the first image comprises:
acquiring description information of the first image; and
determining, based on the description information of the first image, a guided image that matches at least one target part of the target object.

3. The method according to claim 1, wherein, obtaining the reconstructed image by subjecting the first image to the guide reconstruction based on the at least one guided image of the first image comprises:
executing affine transformation of the at least one guided image in accordance with a current pose of the target object in the first image to obtain an affine image in the current pose corresponding to the guided image;
extracting, in accordance with at least one target part, which matches the target object, in the at least one guided image, a sub-image of the at least one target part from the affine image corresponding to the guided image; and
obtaining the reconstructed image based on the extracted sub-image and the first image.

4. The method according to claim 3, wherein, obtaining the reconstructed image based on the extracted sub-image and the first image comprises:
obtaining the reconstructed image by replacing a part, which corresponds to the target part of the sub-image, in the first image with the extracted sub-image, or
obtaining the reconstructed image by subjecting the sub-image and the first image to convolution processing.

5. The method according to claim 1 wherein, obtaining the reconstructed image by subjecting the first image to the guide reconstruction based on the at least one guided image of the first image comprises:
obtaining a second image by executing super-resolution image reconstruction processing of the first image, resolution of the second image being higher than that of the first image;
executing affine transformation of the at least one guided image in accordance with a current pose of the target object in the second image to obtain an affine image in the current pose corresponding to the guided image;
extracting, in accordance with at least one target part, which matches the object, in the at least one guided image, a sub-image of the at least one target part from the affine image corresponding to the guided image; and
obtaining the reconstructed image based on the extracted sub-image and the second image.

6. The method according to claim 5, wherein, obtaining the reconstructed image based on the extracted sub-image and the second image comprises:
obtaining the reconstructed image by replacing a part, which corresponds to the target part in the sub-image, in the second image with the extracted sub-image, or
obtaining the reconstructed image by subjecting the sub-image and the second image to convolution processing.

7. The method according to claim 1, wherein, the method further comprises:
determining identity information that matches the object by executing identity recognition with the reconstructed image.

8. The method according to claim 5, wherein, obtaining the second image by executing the super-resolution image reconstruction processing of the first image is executed by a first neural network, and the method further comprises a step of training the first neural network, comprising:
acquiring a first training image set, the first training image set including a plurality of first training images and first surveillance data corresponding to the first training images;
inputting at least one first training image in the first training image set to the first neural network to execute the super-resolution image reconstruction processing, to obtain a predicted super-resolution image corresponding to the first training image;
inputting the predicted super-resolution image to a first adversarial network, a first feature recognition network and a first image semantic segmentation network respectively, to obtain a discrimination result, a feature recognition result and an image segmentation result of the predicted super-resolution image; and
obtaining a first network loss in accordance with the discrimination result, the feature recognition result and the image segmentation result of the predicted super-resolution image, and back-adjusting parameters for the first neural network based on the first network loss until a first training requirement is met.

9. The method according to claim 8, wherein, obtaining the first network loss in accordance with the discrimination result, the feature recognition result and the image segmentation result of the predicted super-resolution image comprises:
determining a first pixel loss from the predicted super-resolution image corresponding to the first training image, and from a first standard image, which corresponds to the first training image, in the first surveillance data;
obtaining a first adversarial loss based on the discrimination result of the predicted super-resolution image and the discrimination result of the first standard image by the first adversarial network;
determining a first perceptual loss by nonlinearly processing the predicted super-resolution image and the first standard image;
obtaining a first heat map loss based on the feature recognition result of the predicted super-resolution image and a first standard feature in the first surveillance data;
obtaining a first segmentation loss based on the image segmentation result of the predicted super-resolution image and a first standard segmentation result, which corresponds to a first training sample, in the first surveillance data; and
obtaining the first network loss by a weighted sum of the first adversarial loss, the first pixel loss, the first perceptual loss, the first heat map loss and the first segmentation loss.

10. The method according to claim 1, wherein, the guide reconstruction is executed by a second neural network to obtain the reconstructed image, and the method further comprises a step of training the second neural network, comprising:
acquiring a second training image set, the second training image set including second training images, second surveillance data and guided training images corresponding to the second training images;
obtaining a training affine image by subjecting the guided training image to affine transformation in accordance with the second training image, and obtaining, by inputting the training affine image and the second training image to the second neural network to execute the guide reconstruction of the second training image, a reconstructed prediction image of the second training image;
inputting the reconstructed prediction image to a second adversarial network, a second feature recognition network and a second image semantic segmentation network respectively, to obtain a discrimination result, a feature recognition result and an image segmentation result of the reconstructed prediction image; and
obtaining a second network loss of the second neural network in accordance with the discrimination result, the feature recognition result and the image segmentation result of the reconstructed prediction image, and back-adjusting parameters for the second neural network based on the second network loss until a second training requirement is met.

11. The method according to claim 10, wherein, obtaining the second network loss of the second neural network in accordance with the discrimination result, the feature recognition result and the image segmentation result of the reconstructed prediction image corresponding to the training image comprises:
obtaining a global loss and a local loss in accordance with the discrimination result, the feature recognition result and the image segmentation result of the reconstructed prediction image corresponding to the second training image; and
obtaining the second network loss by a weighted sum of the global loss and the local loss.

12. The method according to claim 11, wherein, obtaining the global loss in accordance with the discrimination result, the feature recognition result and the image segmentation result of the reconstructed prediction image corresponding to the training image comprises:
determining a second pixel loss from the reconstructed prediction image corresponding to the second training image, and from a second standard image, which corresponds to the second training image, in the second surveillance data;
obtaining a second adversarial loss based on the discrimination result of the reconstructed prediction image and the discrimination result of the second standard image by the second adversarial network;
determining a second perceptual loss by nonlinearly processing the reconstructed prediction image and the second standard image;
obtaining a second heat map loss based on the feature recognition result of the reconstructed prediction image and a second standard feature in the second surveillance data;
obtaining a second segmentation loss based on the image segmentation result of the reconstructed prediction image and a second standard segmentation result in the second surveillance data; and
obtaining the global loss by a weighted sum of the second adversarial loss, the second pixel loss, the second perceptual loss, the second heat map loss and the second segmentation loss.

13. The method according to claim 11, wherein, obtaining the local loss based on the discrimination result, the feature recognition result and the image segmentation result of the reconstructed prediction image corresponding to the training image comprises:
extracting a part sub-image of at least one part from the reconstructed prediction image, and inputting the part sub-image of the at least one part to an adversarial network, a feature recognition network and an image semantic segmentation network, to obtain a discrimination result, a feature recognition result and an image segmentation result of the part sub-image of the at least one part;
determining a third adversarial loss of the at least one part from the discrimination result of the part sub-image of the at least one part, and from the discrimination result of the part sub-image of the at least one part in the second standard image corresponding to the second training image by the second adversarial network;
obtaining a third heat map loss of the at least one part based on the feature recognition result of the part sub-image of the at least one part and a standard feature of the at least one part in the second surveillance data;
obtaining a third segmentation loss of the at least one part based on the image segmentation result of the part sub-image of the at least one part and the standard segmentation result of the at least one part in the second surveillance data; and
obtaining a local loss of the network by a weighted sum of the third adversarial loss, the third heat map loss and the third segmentation loss of the at least one part.

14. An electronic device, comprising:
a processor; and
a memory configured to store processor-executable instructions;
wherein, the processor is configured to invoke instructions stored in the memory so as to:
acquire a first image;
acquire at least one guided image of the first image, the guided image including guide information of a target object in the first image; and
obtain a reconstructed image by subjecting the first image to a guide reconstruction based on the at least one guided image of the first image.

15. The apparatus according to claim 14, wherein, acquiring the at least one guided image of the first image comprises:
acquiring description information of the first image; and
determining, based on the description information of the first image, a guided image that matches at least one target part of the target object.

16. The apparatus according to claim 14, wherein, obtaining the reconstructed image by subjecting the first image to the guide reconstruction based on the at least one guided image of the first image comprises:
executing affine transformation of the at least one guided image in accordance with a current pose of the target object in the first image to obtain an affine image in the current pose corresponding to the guided image;
extracting, in accordance with at least one target part, which matches the target object, in the at least one guided image, a sub-image of the at least one target part from the affine image corresponding to the guided image; and
obtaining the reconstructed image based on the extracted sub-image and the first image.

17. The apparatus according to claim 16, wherein, obtaining the reconstructed image based on the extracted sub-image and the first image comprises:
obtaining the reconstructed image by replacing a part, which corresponds to the target part in the sub-image, in the first image with the extracted sub-image, or
obtaining the reconstructed image by subjecting the sub-image and the first image to convolution processing.

18. The apparatus according to claim 14, wherein, obtaining the reconstructed image by subjecting the first image to the guide reconstruction based on the at least one guided image of the first image comprises:
executing super-resolution image reconstruction processing of the first image to obtain a second image, resolution of the second image being higher than that of the first image;
executing affine transformation of the at least one guided image in accordance with a current pose of the target object in the second image to obtain an affine image in the current pose corresponding to the guided image;
extracting, in accordance with at least one target part, which matches the object, in the at least one guided image, a sub-image of the at least one target part from the affine image corresponding to the guided image; and
obtaining the reconstructed image based on the extracted sub-image and the second image.

19. The apparatus according to claim 18, wherein, obtaining the reconstructed image based on the extracted sub-image and the second image comprises:
obtaining the reconstructed image by replacing a part, which corresponds to the target part in the sub-image, in the second image with the extracted sub-image, or
obtaining the reconstructed image by subjecting the sub-image and the second image to convolution processing.

20. A non-transitory computer readable storage medium having computer program instructions stored thereon, wherein when the computer program instructions are executed by a processor, the processor is caused to perform the operations of:
acquiring a first image;
acquiring at least one guided image of the first image, the guided image including guide information of a target object in the first image; and
obtaining a reconstructed image by subjecting the first image to a guide reconstruction based on the at least one guided image of the first image.
